(19) United States
(12) Patent Application Publication
(10) Pub. No.: US 2026/0036728 A1
(43) Pub. Date: Feb. 5, 2026

(54) OPTICAL FILM

(71) Applicant: CM VISUAL TECHNOLOGY CORPORATION, TAINAN CITY (TW)

(72) Inventor: Hsin Wen CHANG, TAINAN CITY (TW)

(21) Appl. No.: 19/218,631

(22) Filed: May 27, 2025

Related U.S. Application Data
(60) Provisional application No. 63/678,520, filed on Aug. 1, 2024.

(51) Int. Cl. G02B 5/18

(52) U.S. Cl. CPC G02B 5/1809; G02B 5/1814

(57) ABSTRACT

The optical film includes a film body and a two-dimensional grating structure. The film body has a top surface. The two-dimensional grating structure is on the top surface of the film body, in which the two-dimensional grating structure includes an array of micro-structures in a first dimension and a second dimension intersecting the first dimension, the micro-structures are arranged as plural groups repeated by a first period in a first period direction, and at least two of the micro-structures in each of the groups are arranged in a second period in a second period direction, in which the second period is less than the first period.

### CROSS-REFERENCE TO RELATED APPLICATION

This application claims priority to U.S. Provisional Application Ser. No. 63/678,520, filed Aug. 1, 2024, which is herein incorporated by reference in its entirety.

### BACKGROUND

### Technical Field

The present disclosure relates to an optical film.

### Description of Related Art

Recently, displays have been used in a wide range of electronic products such as personal computers, laptops, digital cameras, smartphones, tablet PCs and LCD TVs. Optical films are an important component of displays and are used to solve problems that may arise in the design of displays. Optical films can improve display quality through the physical properties of the optical films.

### SUMMARY

According to some embodiments of the present disclosure, an optical film is provided. The optical film may be a one-dimensional grating structure, a two-dimensional grating structure or a combination thereof. The one-dimensional grating structure or one of dimensions of the two-dimensional grating structure of the optical film may have different groups of periodic micro-structures, in which the periodic micro-structures are arranged in a combination of two different periods, and one of periods is larger than the other. One group of periodic micro-structures may be intersected with the other group of periodic micro-structures. Furthermore, the optical film has a primary region formed by diffraction points of the periodic micro-structures, in which the energy of the primary region is more than 70% of the energy of an incident light, and the energy differences between different regions of the primary region are less than 20%. These microstructures may homogenize the incident light through scattering and diffraction effects, preventing an excessive concentration of light at specific angles, thereby reducing the visual perception of sparkles, so that the optical film may improve the performance of a display device.

According to some embodiments of the present disclosure, an optical film is provided. The optical film includes a film body and a two-dimensional grating structure. The film body has a top surface. The two-dimensional grating structure is on the top surface of the film body, in which the two-dimensional grating structure includes an array of micro-structures in a first dimension and a second dimension intersecting the first dimension, the micro-structures are arranged as plural groups repeated by a first period in a first period direction, and at least two of the micro-structures in each of the groups are arranged in a second period in a second period direction, in which the second period is less than the first period.

According to some embodiments of the present disclosure, an angle between the first dimension and the second dimension is in a range from 70 degrees to 90 degrees.

According to some embodiments of the present disclosure, the second period direction intersects the first period direction.

According to some embodiments of the present disclosure, an angle between the first period direction and the second period direction is in a range from 40 degrees to 90 degrees.

According to some embodiments of the present disclosure, the second period direction is parallel with the first period direction.

According to some embodiments of the present disclosure, at least two of the micro-structures in the first dimension have peaks misaligned from each other in the first dimension.

According to some embodiments of the present disclosure, the two-dimensional grating structure or one-dimensional grating structures has plural first diffraction points and second diffraction points, wherein the second diffraction points surround the first diffraction points to form a laser pattern.

According to some embodiments of the present disclosure, the laser pattern has a first region and a second region adjacent to the first region, wherein energy of the first region is greater than energy of the second region.

According to some embodiments of the present disclosure, the first region has plural sub regions, wherein energy differences of the sub regions are between 0% and 20%.

According to some embodiments of the present disclosure, the first period is between 1 μm and 50 μm.

According to some embodiments of the present disclosure, the second period is between 0.5 μm and 20 μm.

According to some embodiments of the present disclosure, heights of micro-structures are in a range from one-tenth to twice of the second period.

According to some embodiments of the present disclosure, at least two of the micro-structures in each of the groups are arranged in a third period, in which the third period is less the first period in the second period direction, and the third period is different from the second period.

According to some embodiments of the present disclosure, an optical film

is provided. The optical film includes a film body, a first one-dimensional grating-structure and a second one-dimensional grating-structure. The film body has a top surface and a bottom surface. The first one-dimensional grating-structure is disposed on the top surface of the film body, in which the first one-dimensional grating-structure has plural first micro-structures arranged in a first dimension, in which the first micro-structures are arranged as plural groups repeated by a first period in a first period direction, and at least two of the first micro-structures in each of the groups are arranged in a second period, in which the second period is less than the first period.

According to some embodiments of the present disclosure, the first period is between 1 μm and 50 μm.

According to some embodiments of the present disclosure, the second period is between 0.5 μm and 20 μm.

According to some embodiments of the present disclosure, heights of micro-structures are in a range from one-tenth to twice of the second period.

According to some embodiments of the present disclosure, at least two of the first micro-structures in each of the groups are arranged in a third period, in which the third period is less the first period, and the third period is different from the second period.

### BRIEF DESCRIPTION OF THE DRAWINGS

FIGS. 1A through 1C are schematic diagrams of an optical film in accordance with some embodiments of the present disclosure.

FIG. 2A is a top view of micro-structures in accordance with some embodiments of the present disclosure.

FIGS. 2B and 2C are cross-section views of FIG. 2A taken along a line A-A′.

FIGS. 2D and 2E exemplarily illustrate various arrangements of the micro-structures in FIGS. 2A, 2B, and 2C.

FIG. 3A is a top view of micro-structures in accordance with some embodiments of the present disclosure.

FIG. 3B is a cross-section view of FIG. 3A taken along a line B-B′.

FIGS. 3C and 3D exemplarily illustrate various arrangements of micro-structures in FIGS. 3A and 3B.

FIG. 4A is a top view of micro-structures in accordance with some embodiments of the present disclosure.

FIG. 4B exemplarily illustrates an arrangement of micro-structures in FIG. 4A.

FIG. 5A is a top view of micro-structures in accordance with some embodiments of the present disclosure.

FIG. 5B exemplarily illustrates an arrangement of micro-structures in FIG. 5A

FIG. 6A is a top view of peaks of micro-structures in accordance with some embodiments of the present disclosure.

FIGS. 6B and 6C exemplarily illustrate various arrangements of micro-structures in FIG. 6A.

FIG. 7A is a top view of a two-dimensional grating unit in accordance with some embodiments of the present disclosure.

FIG. 7B exemplarily illustrates an arrangement of the two-dimensional grating unit in FIG. 7A.

FIG. 7C exemplarily illustrates an arrangement of a two-dimensional grating unit in accordance with some embodiments of the present disclosure.

FIG. 8A is a schematic diagram of an incident light incident on an optical film in accordance with some embodiments of the present disclosure.

FIG. 8B is a laser pattern of an optical film in accordance with some embodiments of the present disclosure.

FIG. 8C is a diffraction point diagram of FIG. 8B.

FIG. 9 is a schematic diagram of a display device in accordance with some embodiments of the present disclosure.

FIG. 10 is a schematic diagram of a display device in accordance with some embodiments of the present disclosure.

### DETAILED DESCRIPTION

The embodiments of the present disclosure are discussed in detail below. However, it should be understood that the embodiments provide many applicable concepts that can be implemented in a wide variety of specific contexts. The embodiments discussed and disclosed are for illustrative purposes only and are not intended to limit the scope of the present disclosure. As used herein, the terms ‘first’, ‘second’, etc., do not specifically refer to order or sequence, but are intended only to distinguish components or operations that are described in the same technical terms.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, “around,” “about,” “approximately,” or “substantially” shall generally mean within 20 percent, or within 10 percent, or within 5 percent of a given value or range. Numerical quantities given herein are approximate, meaning that the term “around,” “about,” “approximately,” or “substantially” can be inferred if not expressly stated.

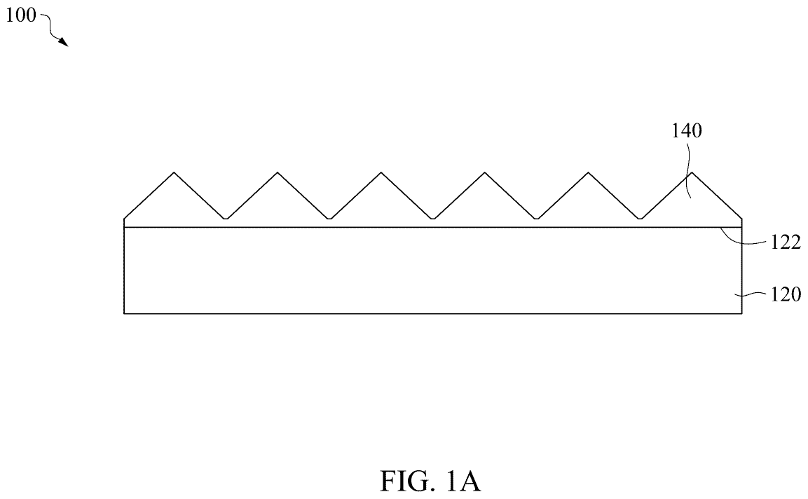

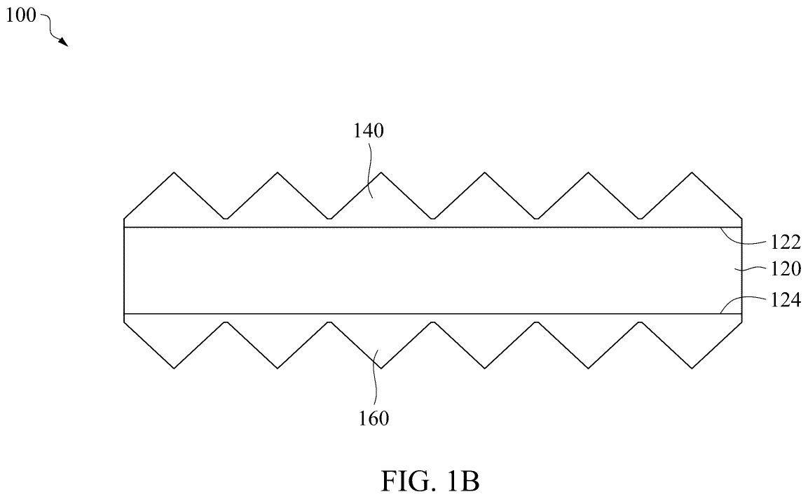

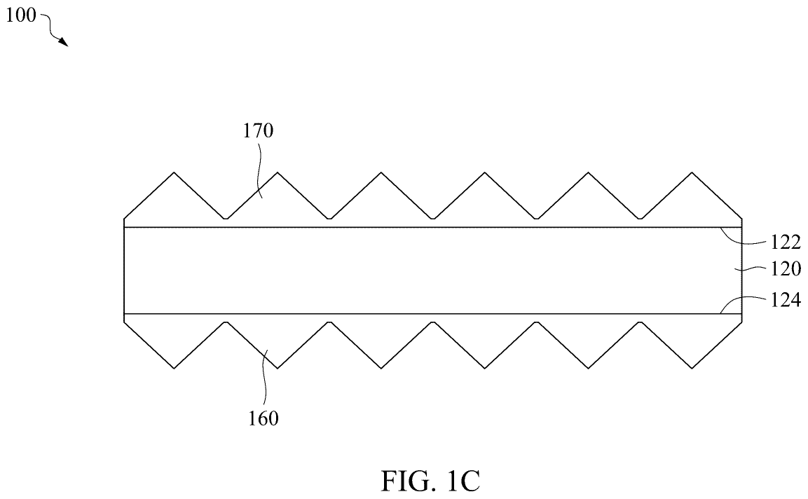

Referring to FIGS. 1A, 1B and 1C, FIGS. 1A through 1C are schematic diagrams of an optical film 100 in accordance with some embodiments of the present disclosure. In some embodiments, the optical film 100 includes a film body 120, a two-dimensional grating structure 140, and one-dimensional grating structures 160 and 170. The two-dimensional grating structure 140 may be selectively formed on a top surface 122 or a bottom surface 124 of the film body 120. The one-dimensional grating structure 160 may be selectively formed on the bottom surface 124 of the film body 120, and the one-dimensional grating structure 170 may be selectively formed on the top surface 122 of the film body 120. For example, the two-dimensional grating structure 140 may be selectively formed on the top surface 122 of the film body 120 by a nano-imprint lithography (NIL) process. In another example, the two-dimensional grating structure 140 may be selectively formed on the top surface 122 and the bottom surface 124 of the film body 120 by the NIL process. In another example, the two-dimensional grating structure 140 may be selectively formed on the top surface 122 of the film body 120 by the NIL process, and the one-dimensional grating structure 160 may be selectively formed on the bottom surface 124 of the film body 120 by the NIL process. In the other example, the one-dimensional grating structure 170 may be selectively formed on the top surface 122 of the film body 120, and the one-dimensional grating structure 160 may be selectively formed on the bottom surface 124 of the film body 120 by the NIL process. However, it should be notice that the two-dimensional grating structure 140 and the one-dimensional grating structure 160 may adopt any appropriate process without such limitations.

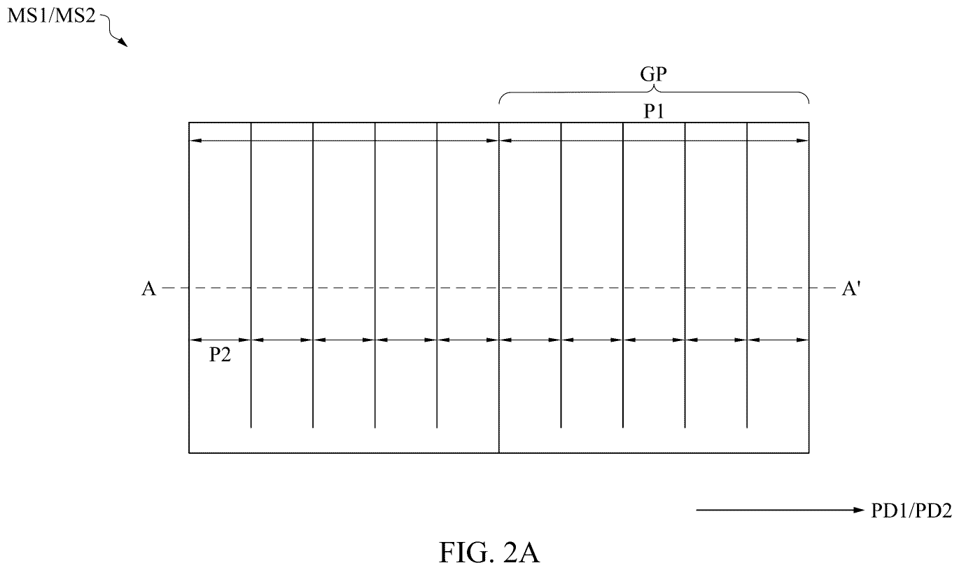

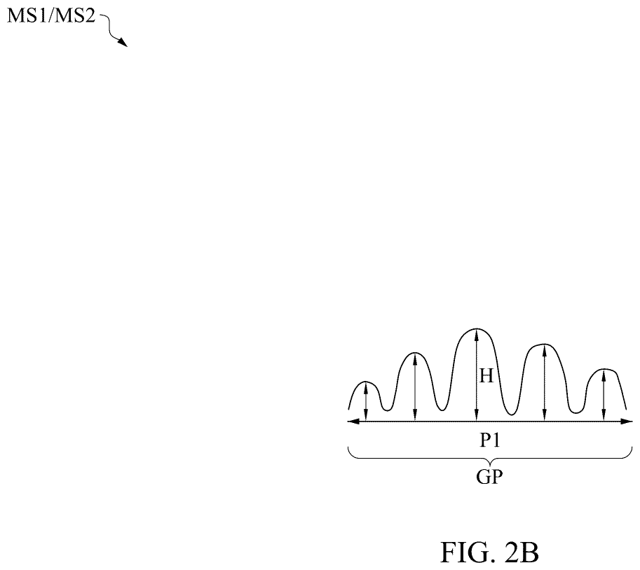

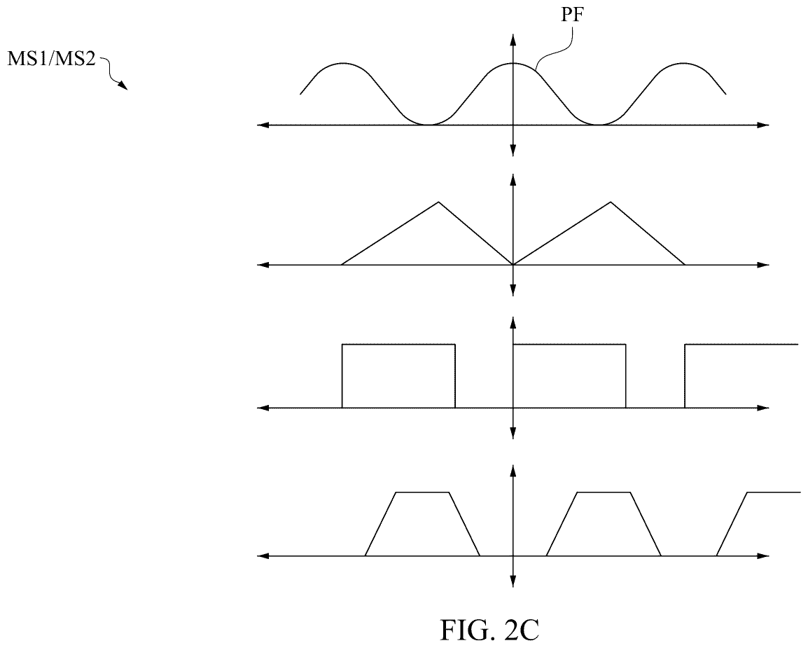

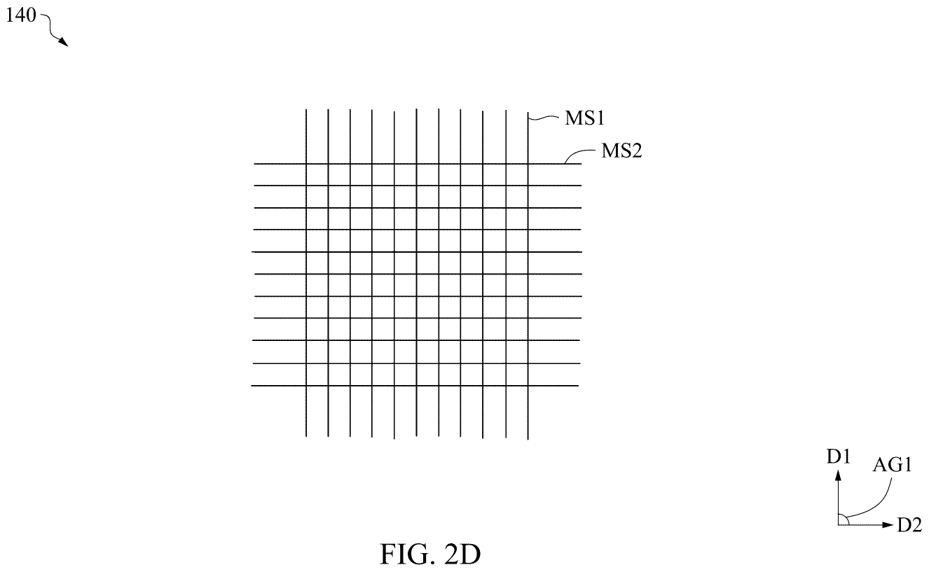

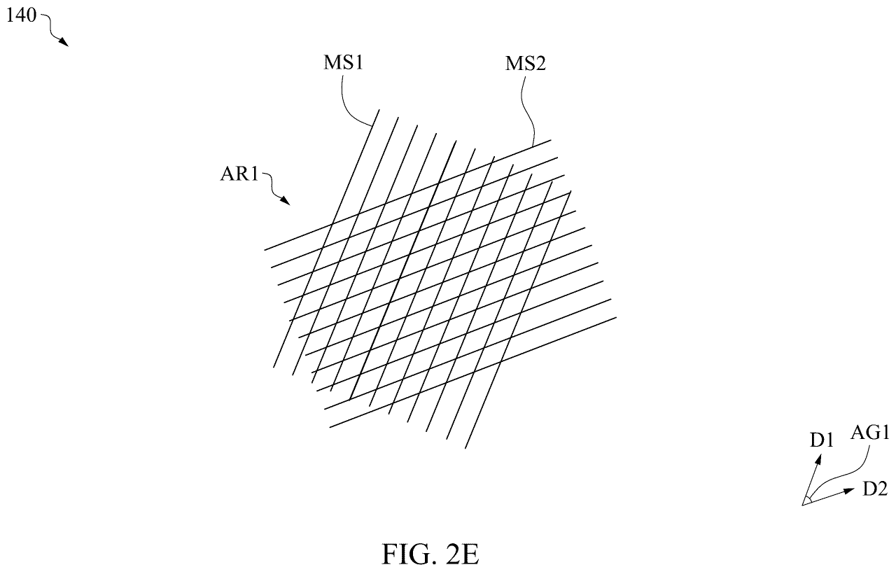

Referring to FIG. 2A, FIG. 2A is a top view of micro-structures MS1 or MS2 in accordance with some embodiments of the present disclosure. In some embodiments, the one-dimensional grating structure 160 (referring to FIGS. 1A, 1B and 1C) includes plural micro-structures MS1. The one-dimensional grating structure 170 (referring to FIGS. 1A, 1B, and 1C) includes plural micro-structures MS2. The micro-structures MS1 are arranged as plural groups GP repeated by a period P1 in a period direction PD1, and at least two of the micro-structures MS1 in each of the groups GP are arranged in a period P2 in a period direction PD2, in which the period P2 is less than the period P1, and the period P1 contains two or more periods P2. For example, in present embodiment, the period P1 may be a fixed single value, e.g., 25 μm, and the period P2 may be a fixed single value, e.g., 5 μm. In some embodiments, the period P1 may vary between 1 μm and 50 μm, and the period P2 may vary between 0.5 μm and 20 μm. Furthermore, the period direction PD1 and the period direction PD2 may be adjusted according to the functional requirements. For example, in present embodiment, the period direction PD2 is parallel with the period direction PD1. In addition, characterizations of the micro-structures MS2 are substantially same as the characterizations of micro-structures MS1. Therefore, the characterizations of micro-structures MS2 are not repeated herein.

Referring to FIGS. 2B and 2C, FIGS. 2B and 2C are cross-section views of FIGS. 2A taken along a line A-A′. In some embodiments, heights H of the micro-structures MS1 may be adjusted according to the functional requirements. For example, in present embodiment, the heights H of the micro-structures MS1 are in a range from 3 μm to 5 μm. In some embodiments, the heights H of the micro-structures MS1 are in a range from one-tenth to twice of the period P2.

Furthermore, profiles PF of the micro-structures MS1 may be adjusted according to the functional requirements. For example, in present embodiment, profiles PF of the micro-structures MS1 may be a sinusoidal wave, a triangular wave, a rectangular wave, a trapezoid wave, similar waves or a combination thereof. In addition, characterizations of the micro-structures MS2 are substantially the same as the characterizations of micro-structures MS1. Therefore, the characterizations of micro-structures MS2 are not repeated herein.

Referring to FIGS. 2D and 2E, FIGS. 2D and 2E exemplarily illustrate various arrangements of the micro-structures MS1 or MS2 in FIGS. 2A, 2B, and 2C. In some embodiments, the one-dimensional grating structures 160 (referring to FIGS. 1A, 1B and 1C) and 170 (referring to FIGS. 1A, 1B, and 1C) may be intersected into the two-dimensional grating structure 140. For example, in the present embodiment, the two-dimensional grating structure 140 includes plural micro-structures MS1 of the one-dimensional grating structure 160 (referring to FIGS. 1A, 1B and 1C) in a dimension D1 and plural micro-structures MS2 of the one-dimensional grating structure 170 (referring to FIGS. 1A, 1B and 1C) in a dimension D2. The micro-structures MS2 in the dimension D2 may be designed to intersect the micro-structures MS1 in the dimension D1, so that the micro-structures MS1 and MS2 may form an array AR1. For example, in one embodiment, an angle AG1 between the dimension D1 and the dimension D2 is 90 degrees. In another embodiment, the angle AG1 between the dimension D1 and the dimension D2 is 70 degrees. In the other embodiment, the angle AG1 between the dimension D1 and the dimension D2 is in a range from 70 degrees to 90 degrees.

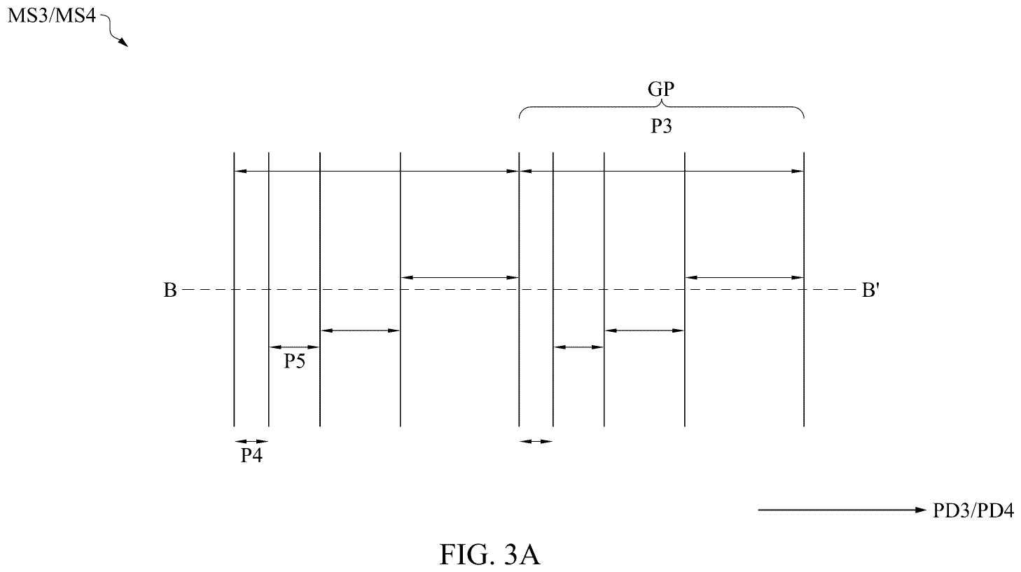

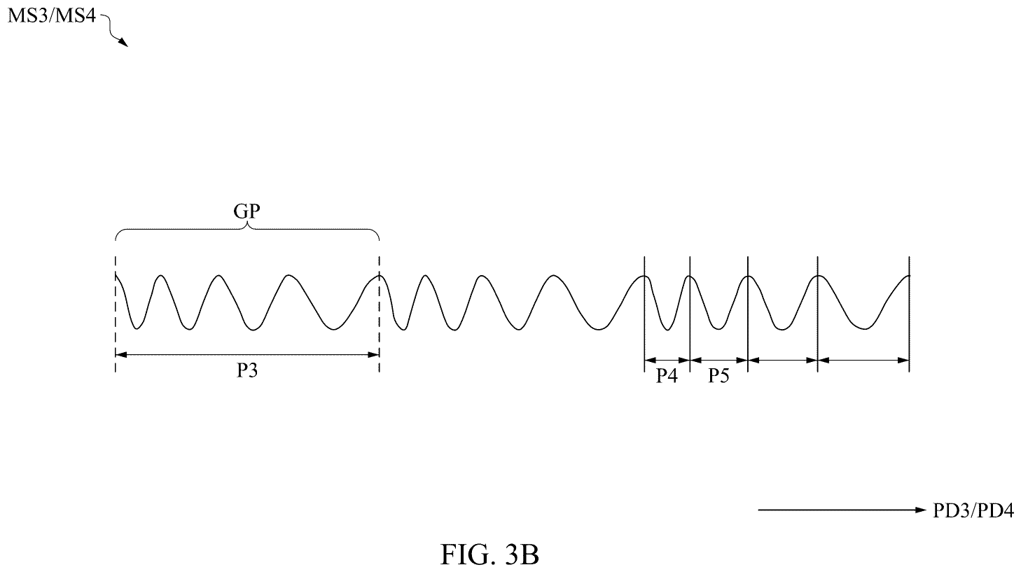

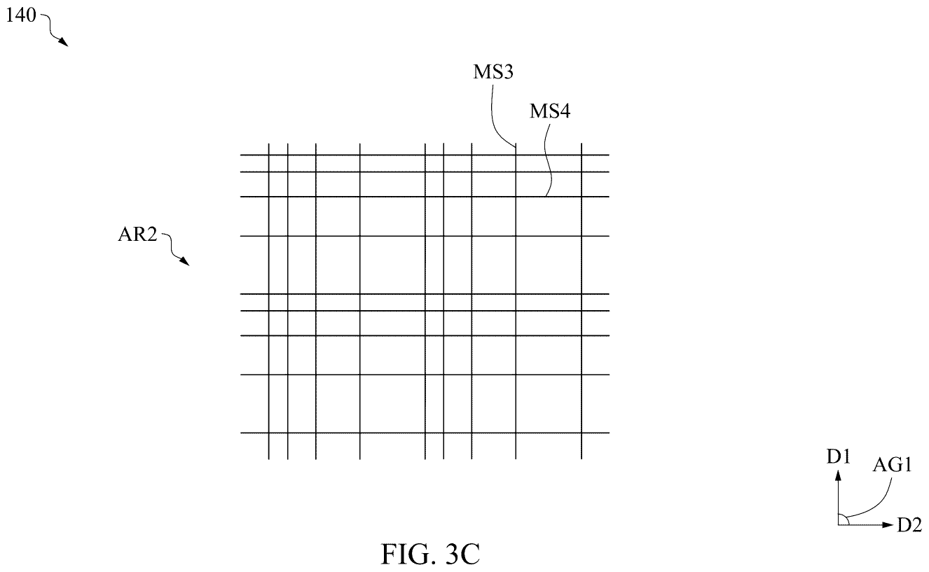

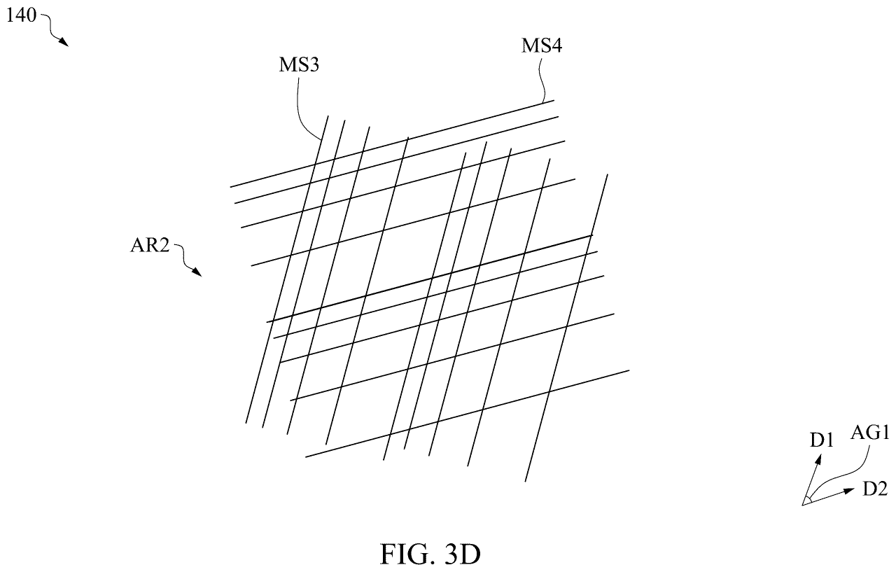

Referring to FIGS. 3A and 3B, FIG. 3A is a top view of micro-structures MS3 or MS4 in accordance with some embodiments of the present disclosure. FIG. 3B is a cross-section view of FIG. 3A taken along a line B-B′. In some embodiments, the one-dimensional grating structure 160 (referring to FIGS. 1A, 1B and 1C) includes plural micro-structures MS3. The one-dimensional grating structure 170 (referring to FIGS. 1A, 1B and 1C) includes plural micro-structures MS4. The micro-structures MS3 are arranged as plural groups GP1 repeated by the period P3 in a period direction PD3, at least two of the micro-structures MS3 in each of the groups GP1 are arranged in a period P4 in a period direction PD4, and at least two of the micro-structures MS3 in each of the groups GP1 are arranged in a period P5 in the period direction PD4. The period P3 contains two or more periods P4 or P5, in which the periods P4 and P5 are less than the period P3, and the period P5 is different from the period P4. For example, in present embodiment, the period P3 may be a fixed single value, e.g., 22 μm, the period P4 may vary between 4 μm and 7 μm, and the period P5 may vary between 5 μm and 7 μm. In some embodiments, the period P3 may vary between 1 μm and 50 μm, and the periods P4 and P5 may vary between 0.5 μm and 20 μm. Furthermore, the period direction PD3 and the period direction PD4 may be adjusted according to the functional requirements. For example, in present embodiment, the period direction PD4 is parallel with the period direction PD3. In addition, characterizations of the micro-structures MS4 are substantially same as the characterizations of micro-structures MS3. Therefore, the characterizations of micro-structures MS4 are not repeated herein.

Referring to FIGS. 3C and 3D, FIGS. 3C and 3D exemplarily illustrate various arrangements of micro-structures MS3 and MS4 in FIGS. 3A and 3B. In some embodiments, the one-dimensional grating structures 160 (referring to FIGS. 1A, 1B, and 1C) and 170 (referring to FIGS. 1A, 1B, and 1C) may be intersected into the two-dimensional grating structure 140. For example, in the present embodiment, the two-dimensional grating structure 140 includes plural micro-structures MS3 of the one-dimensional grating structure 160 (referring to FIGS. 1A, 1B and 1C) in the dimension D1 and plural micro-structures MS4 of the one-dimensional grating structure 170 (referring to FIGS. 1A, 1B and 1C) in the dimension D2. The micro-structures MS4 in the dimension D2 may be designed to intersect the micro-structures MS3 in the dimension D1, so that the micro-structures MS3 and MS4 may form an array AR2. For example, in one embodiment, the angle AG1 between the dimension D1 and the dimension D2 is 90 degrees. In another embodiment, the angle AG1 between the dimension D1 and the dimension D2 is 70 degrees. In the other embodiments, the angle AG1 between the dimension D1 and the dimension D2 is in a range from 70 degrees to 90 degrees.

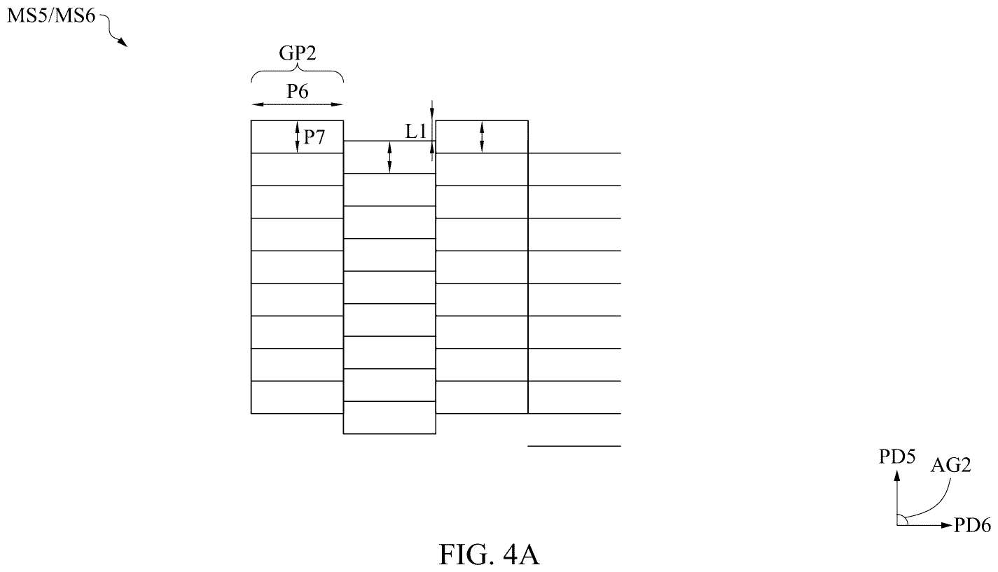

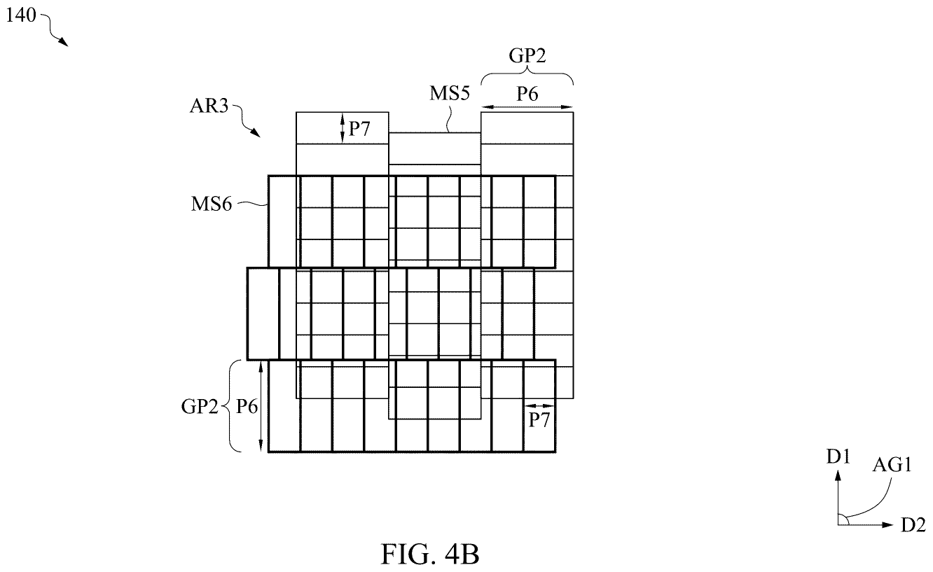

Referring to FIG. 4A, FIG. 4A is a top view of micro-structures MS5 or MS6 in accordance with some embodiments of the present disclosure. In some embodiments, the one-dimensional grating structure 160 (referring to FIGS. 1A, 1B and 1C) includes plural micro-structures MS5. The one-dimensional grating structure 170 (referring to FIGS. 1A, 1B, and 1C) includes plural micro-structures MS6. The micro-structures MS5 are arranged as plural groups GP2 repeated by a period P6 in a period direction PD5, and at least two of the micro-structures MS5 in each of the groups GP2 are arranged in a period P7 in a period direction PD6, in which the period P7 is less than the period P6, and the period P6 contains two or more periods P7. For example, in present embodiment, the period P6 may be a fixed single value, e.g., 15 μm, and the period P7 may be a fixed single value, e.g., 5 μm. In some embodiments, the period P6 may vary between 1 μm and 50 μm, and the period P7 may vary between 0.5 μm and 20 μm.

Furthermore, the micro-structures MS5 in one of the groups GP2 may be misaligned with the micro-structures MS5 in the other of the groups GP2 by a distance L1 to reduce the issue of light splitting. For example, in present embodiment, the distance L1 is less than or equal to the period P7. Furthermore, the period direction PD6 may intersect the period direction PD5. For example, in the present embodiment, an angle AG2 between the period direction PD5 and the period direction PD6 is 90 degree. In some embodiments, the angle AG2 is in a range from 40 degrees to 90 degrees. In addition, characterizations of the micro-structures MS6 are substantially same as the characterizations of micro-structures MS5. Therefore, the characterizations of micro-structures MS6 are not repeated herein.

Referring to FIG. 4B, FIG. 4B exemplarily illustrates various arrangements of micro-structures MS5 and MS6 in FIG. 4A. In some embodiments, the one-dimensional grating structures 160 (referring to FIGS. 1A, 1B, and 1C) and 170 (referring to FIGS. 1A, 1B, and 1C) may be intersected into the two-dimensional grating structure 140. For example, in the present embodiment, the two-dimensional grating structure 140 includes plural micro-structures MS5 of the one-dimensional grating structure 160 (referring to FIGS. 1A, 1B, and 1C) in the dimension D1 and plural micro-structures MS6 of the one-dimensional grating structure 170 (referring to FIGS. 1A, 1B, and 1C) in the dimension D2. The micro-structures MS6 in the dimension D2 may be designed to intersect micro-structures MS5 in the dimension D1, so that the micro-structures MS5 and the micro-structures MS6 may form an array AR3. For example, in present embodiment, the angle AG1 between the dimension D1 and the dimension D2 is 90 degrees. In some embodiments, the angle AG1 between the dimension D1 and the dimension D2 is in a range from 70 degrees to 90 degrees.

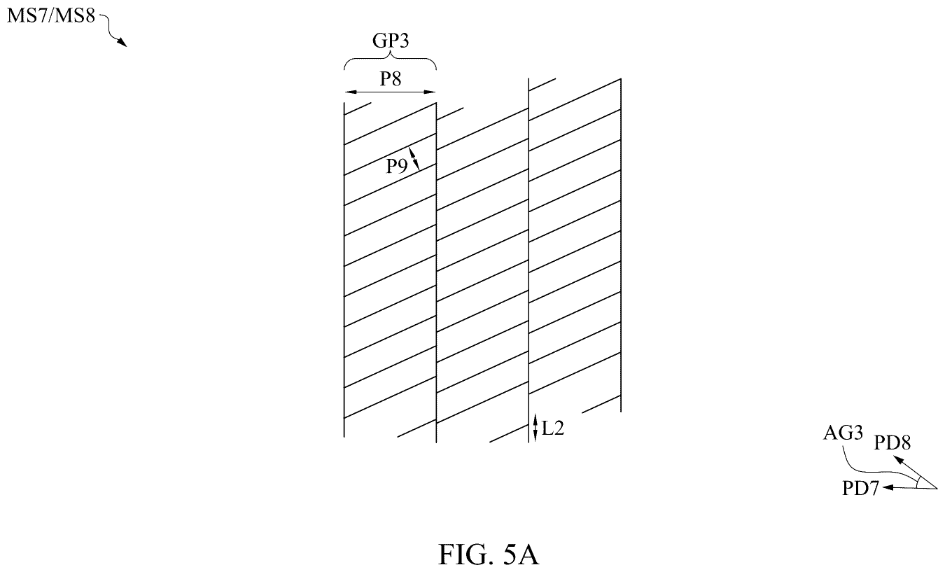

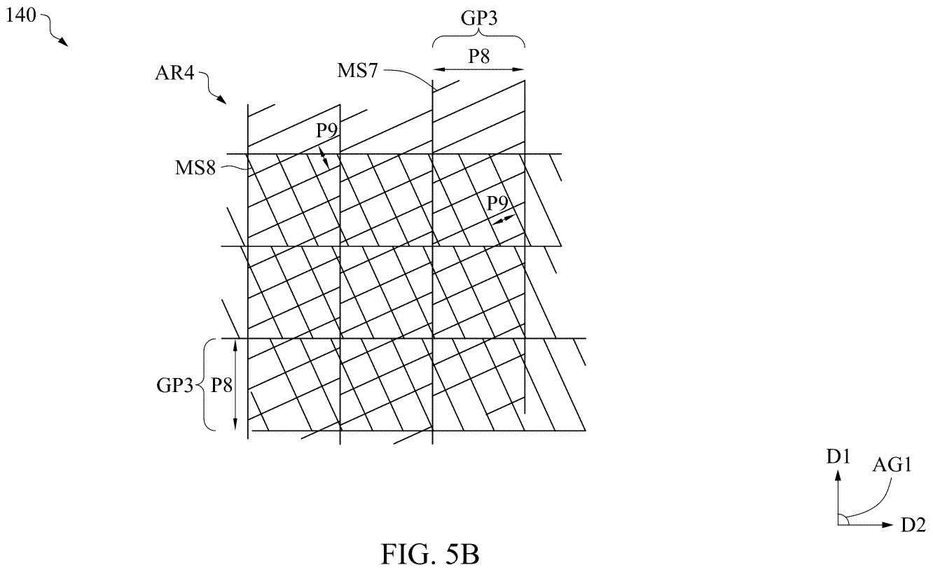

Referring to FIG. 5A, FIG. 5A is a top view of micro-structures MS7 or MS8 in accordance with some embodiments of the present disclosure. In some embodiments, the one-dimensional grating structure 160 (referring to FIGS. 1A, 1B and 1C) includes plural micro-structures MS7. The one-dimensional grating structure 170 (referring to FIGS. 1A, 1B, and 1C) includes plural micro-structures MS8. The micro-structures MS7 are arranged as plural groups GP3 repeated by a period P8 in a period direction PD7, and at least two of the micro-structures MS7 in each of the groups GP3 are arranged in a period P9 in a period direction PD8, in which the period P9 is less than the period P8, and the period P8 contains two or more periods P9. For example, in present embodiment, the period P8 may be a fixed single value, e.g., 15 μm, and the period P9 may be a fixed single value, e.g., 5 μm. In some embodiments, the period P8 may vary between 1 μm and 50 μm, and the period P9 may vary between 0.5 μm and 20 μm.

Furthermore, the micro-structures MS7 in one of the groups GP3 may be misaligned with the micro-structures MS7 in the other of the groups GP3 by a distance L2 to reduce the issue of light splitting. For example, in present embodiment, the distance L2 is less than or equal to the period P9. In addition, the period direction PD8 may intersect the period direction PD7. For example, in the present embodiment, an angle AG3 between the period direction PD7 and the period direction PD8 is 40 degree. In some embodiments, the angle AG3 is in a range from 40 degrees to 90 degrees. In addition, characterizations of the micro-structures MS8 are substantially same as the characterizations of micro-structures MS7. Therefore, the characterizations of micro-structures MS8 are not repeated herein.

Referring to FIG. 5B, FIG. 5B exemplarily illustrates various arrangements of micro-structures MS7 and MS8 in FIG. 5A. In some embodiments, the one-dimensional grating structures 160 (referring to FIGS. 1A, 1B, and 1C) and 170 (referring to FIGS. 1A, 1B, and 1C) may be intersected into the two-dimensional grating structure 140. For example, in the present embodiment, the two-dimensional grating structure 140 may include plural micro-structures MS7 of the one-dimensional grating structure 160 (referring to FIGS. 1A, 1B, and 1C) in the dimension D1 and plural micro-structures MS8 of the one-dimensional grating structure 170 (referring to FIGS. 1A, 1B and 1C) in the dimension D2. The micro-structures MS8 in the dimension D2 may be designed to intersect micro-structures MS7 in the dimension D1, so that the micro-structures MS7 and the micro-structures MS8 may form an array AR4. For example, in present embodiments, the angle AG1 between the dimension D1 and the dimension D2 is 90 degrees. In some embodiments, the angle AG1 between the dimension D1 and the dimension D2 is in a range from 70 degrees to 90 degrees.

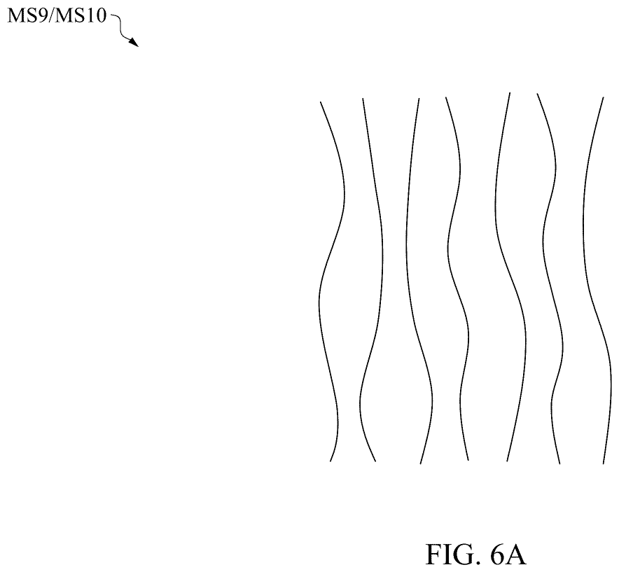

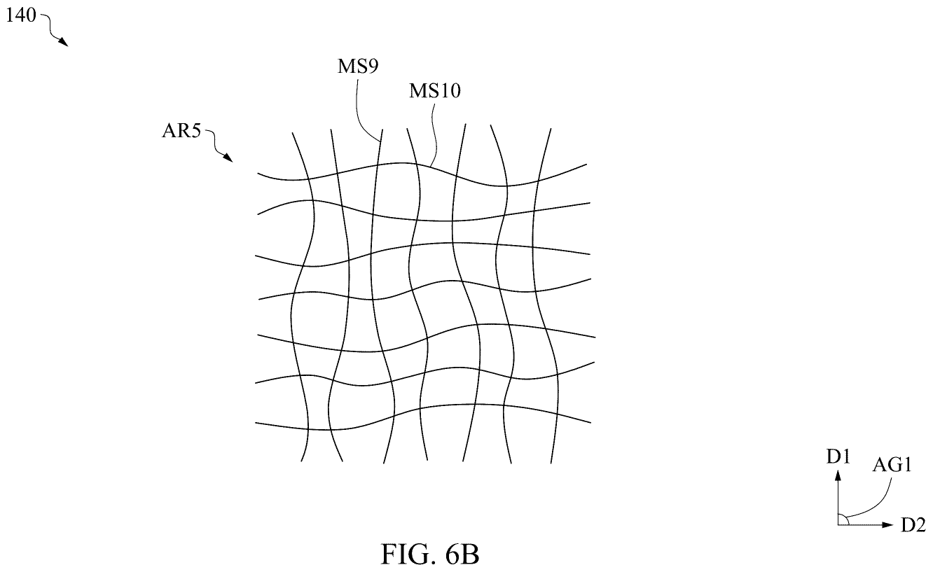

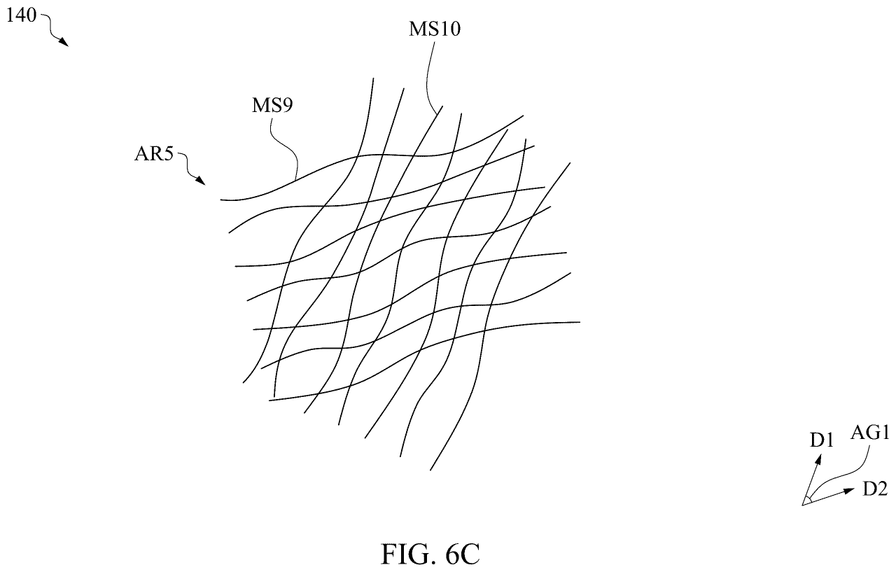

Referring to FIGS. 6A, 6B, and 6C, FIG. 6A is a top view of peaks of micro-structures MS9 or MS10 in accordance with some embodiments of the present disclosure, and FIGS. 6B and 6C exemplarily illustrate various arrangements of the micro-structures MS9 and MS10. In some embodiments, the one-dimensional grating structure 160 (referring to FIGS. 1A, 1B and 1C) includes plural micro-structures MS9. The one-dimensional grating structure 170 (referring to FIGS. 1A, 1B, and 1C) includes plural micro-structures MS10, in which at least two of the micro-structures MS9 in the dimension D1 have peaks misaligned from each other in the dimension D1, and at least two of the micro-structures MS10 in the dimension D2 have peaks misaligned from each other in the dimension D2, thus reducing the interference between the two different pixels of a display device. The micro-structures MS9 and MS10 may adopt similar configurations of the micro-structures described above. For example, in the present embodiment, the micro-structures MS9 may adopt similar configuration of the micro-structures MS1 in FIG. 2A, in which lines of the peaks (such as the crest of the period P1 (referring to FIG. 2A)) of the micro-structures MS9 may be curved. The micro-structures MS10 may adopt similar configuration of the micro-structures MS2 in FIG. 2A, in which lines of the peaks (such as the crest of the period P2 (referring to FIG. 2A)) of the micro-structures MS10 may be curved.

Furthermore, in some embodiments, the one-dimensional grating structures 160 (referring to FIGS. 1A, 1B, and 1C) and 170 (referring to FIGS. 1A, 1B, and 1C) may be intersected into the two-dimensional grating structure 140. For example, in the present embodiment, the two-dimensional grating structure 140 may include plural micro-structures MS9 of the one-dimensional grating structure 160 (referring to FIGS. 1A, 1B, and 1C) in the dimension D1 and plural micro-structures MS10 of the one-dimensional grating structure 170 (referring to FIGS. 1A, 1B, and 1C) in the dimension D2. The micro-structures MS10 in the dimension D2 may be designed to intersect micro-structures MS9 in the dimension D1, so that the micro-structures MS9 and the micro-structures MS10 may form an array AR5. For example, in present embodiments, the angle AG1 between the dimension D1 and the dimension D2 is 90 degrees. In some embodiments, the angle AG1 between the dimension D1 and the dimension D2 is in a range from 70 degrees to 90 degrees.

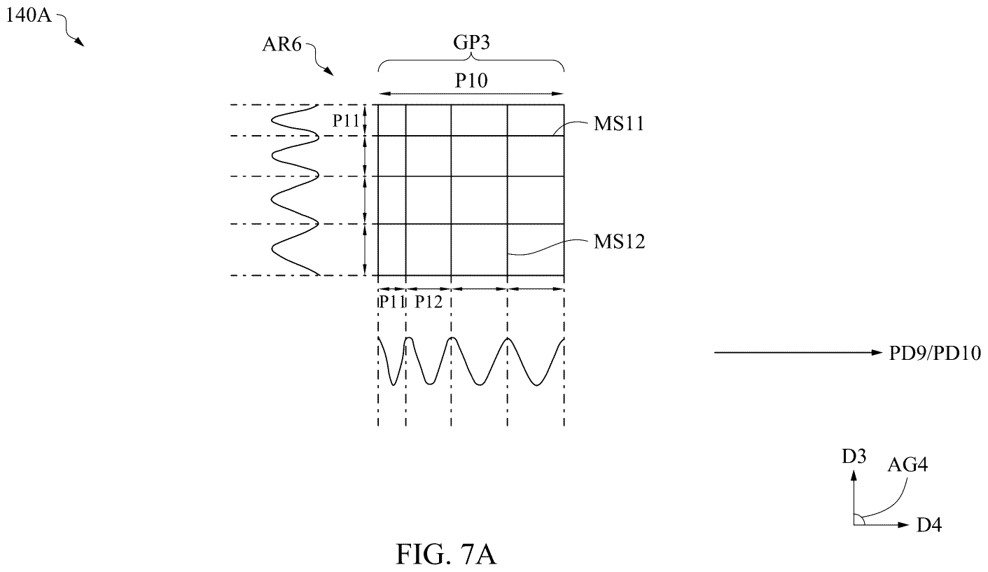

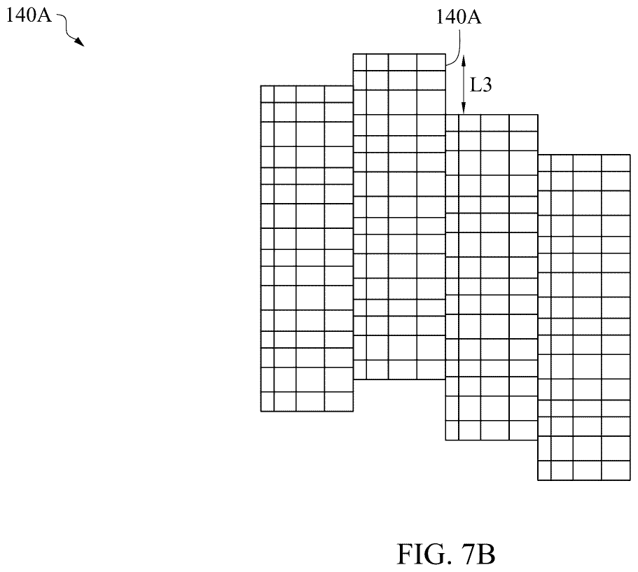

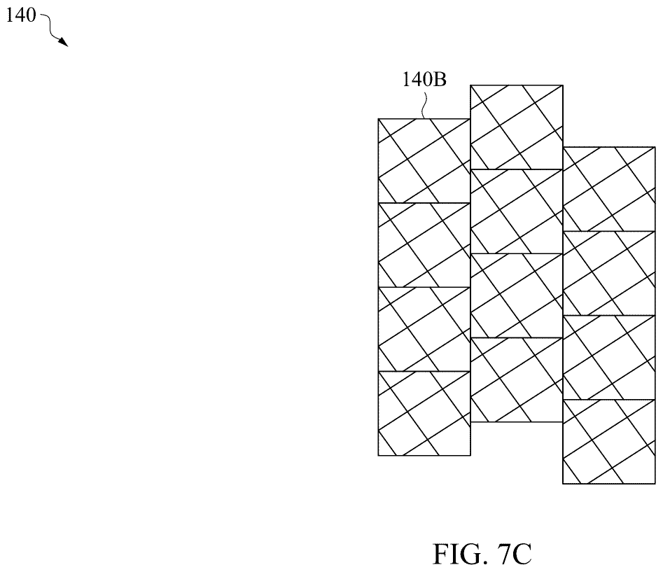

Referring to FIG. 7A, FIG. 7A is a top view of a two-dimensional grating unit 140A in accordance with some embodiments of the present disclosure. In some embodiments, the two-dimensional grating unit 140A includes an array AR6 of micro-structures MS11 in a dimension D4 and micro-structures MS12 in a dimension D3, in which the dimension D3 of the array AR6 intersects the dimension D4 of the array AR6. For example, in the present embodiment, an angle AG4 between the dimensions D3 and D4 is 90 degrees. In some embodiments, the angle AG4 between the dimensions D3 and D4 is in a range from 70 degrees to 90 degrees. Furthermore, the micro-structures MS11 are arranged as plural groups GP4 repeated by a period P10 in a period direction PD9, at least two of the micro-structures MS11 in each of the groups GP4 are arranged in a period P11 in a period direction PD10, and at least two of the micro-structures MS11 in each of the groups GP4 are arranged in a period P12 in the period direction PD10. The period P10 contains two or more periods P11 or P12, in which the period P11 is less than the period P10, the period P12 is less than the period P10, and the period P12 is different from the period P11. For example, in present embodiment, the period P10 may be a fixed single value, e.g., 26 μm, the period P11 may vary between 5 μm and 8 μm, and the period P12 may vary between 6 μm and 8 μm. In some embodiments, the period P10 may vary between 1 μm and 50 μm, and the periods P11 and P12 may vary between 0.5 μm and 20 μm. Furthermore, the period direction PD9 and the period direction PD10 may be adjusted according to the functional requirements. For example, in present embodiment, the period direction PD10 is parallel with the period direction PD9. In some embodiments, the micro-structures MS11 may adopt the similar configuration as the micro-structures MS1, MS3, MS5, MS7, MS9, or a combination thereof. In addition, characterizations of the micro-structures MS12 are substantially same as the characterizations of micro-structures MS11. Therefore, the characterizations of micro-structures MS12 are not repeated herein.

Referring to FIG. 7B, FIG. 7B exemplarily illustrates an arrangement of the two-dimensional grating unit 140A in FIG. 7A. In some embodiments, the two-dimensional grating structure 140 includes plural two-dimensional grating units 140A. The two-dimensional grating units 140A may be spread out on any flat space, e.g., the top surface 122 or the bottom surface 124 of the film body 120 (referring to FIGS. 1A and 1B). Furthermore, at least two of the two-dimensional grating units 140A may be misaligned with each other by a distance L3 to reduce the issue of light splitting. For example, in present embodiment, the distance L3 is less than or equal to the periods P11 (referring to FIG. 7A).

Referring to FIG. 7C, FIG. 7C exemplarily illustrates an arrangement of a two-dimensional grating unit 140B in accordance with some embodiments of the present disclosure. In some embodiments, the two-dimensional grating structure 140 includes plural two-dimensional grating units 140B. The two-dimensional grating units 140B are similar to the two-dimensional grating units 140A in FIGS. 7A and 7B. The followings are the differences between the two-dimensional grating units 140B and 140A. The two-dimensional grating units 140B may be tilted an angle and spread out on any flat space,e.g., the top surface 122 or the bottom surface 124 of the film body 120 (referring to FIGS. 1A and 1B).

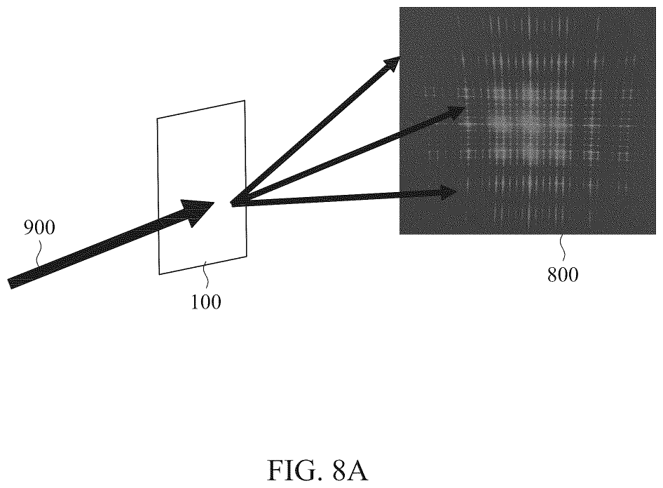

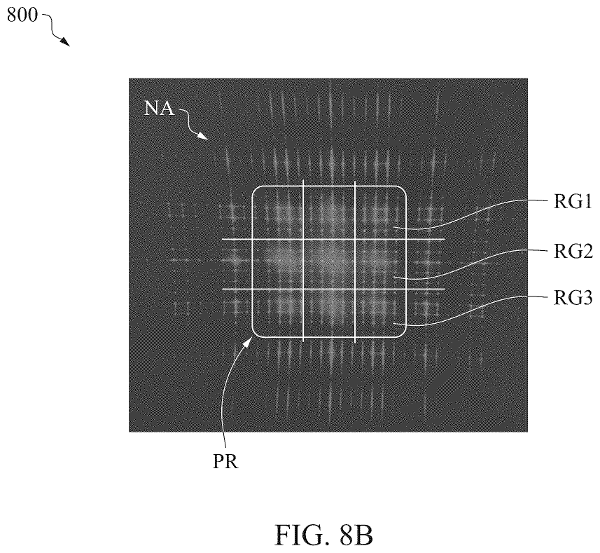

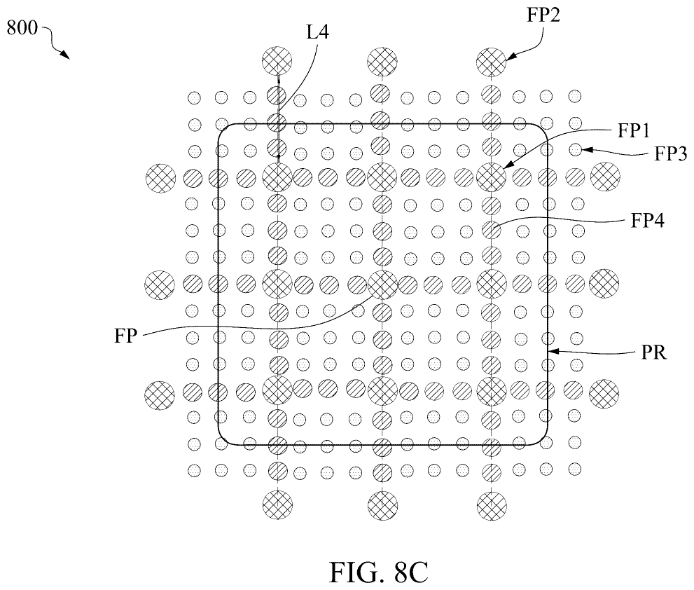

Referring to FIGS. 8A, 8B and 8C, FIG. 8A is a schematic diagram of an incident light 900 incident on the optical film 100 in accordance with some embodiments of the present disclosure. FIG. 8B is a laser pattern 800 of the optical film 100 in accordance with some embodiments of the present disclosure. FIG. 8C is a diffraction point diagram of FIG. 8B. In some embodiments, the laser pattern 800 may be generated by using the incident light 900 incident on the optical film 100, in which the incident light 900 may be a 550 nm green laser. The laser pattern 800 is made of a diffraction point FP and plural diffraction points FP1, FP2, FP3, and FP4 of the two-dimensional grating structure 140 or one-dimensional grating structures 160 and 170 (referring to FIGS. 1A, 1B and 1C) described above. For example, in the present embodiment, the diffraction point FP corresponds to the incidence point of the incident light 900. The diffraction points FP1 and FP2 respectively corresponds to the first order and the second order diffraction points of the period P2 (referring to FIG. 2A), in which the diffraction points FP2 surround and are spaced apart from the diffraction points FP1 by a distance L4. The diffraction points FP3 and FP4 corresponds to the diffraction points of the period P1 (referring to FIG. 2A), in which the diffraction points FP3 and FP4 are between the diffraction points FP1 and FP2, the energy of the diffraction points FP1 and FP2 is larger than the energy of the diffraction points FP3 and FP4, and the energy of the diffraction points FP4 is larger than the energy of the diffraction points FP3. In some embodiments, the diffraction points FP1 and FP2 corresponds to the period P4, P5, P7, P9, P11, or P12 (referring to FIGS. 3A, 4A, 5A, 6A, and 7A), and the diffraction points FP3 corresponds to the period P3, P6, P8, or P10 (referring to FIGS. 3A, 4A, 5A, 6A, and 7A).

Furthermore, the laser pattern 800 has a primary region PR made of the diffraction points FP1, FP2, FP3, and FP4 in a range of the half of the distance L4 and a neighboring region NA adjacent to the primary region PR, in which the energy of the primary region PR is greater than the energy of the neighboring region NA. For example, the energy of the primary region PR is more than 70% of total energy of the incident light 900. The primary region PR has plural sub regions RG1, RG2, and RG3, in which the energy differences between the sub regions RG1 and RG2, the energy differences between the sub regions RG1 and RG3 or the energy differences between sub RG2 and RG3 are between 0% and 20%. In addition, a size of the primary region PR may be adjusted according to the functional requirements. For example, in some embodiments, when the display device has larger pixel size, the two-dimensional grating structure 140 or one-dimensional grating structures 160 and 170 may be designed to be smaller, so that the size of the primary region PR may be larger to match the pixel size of the display device.

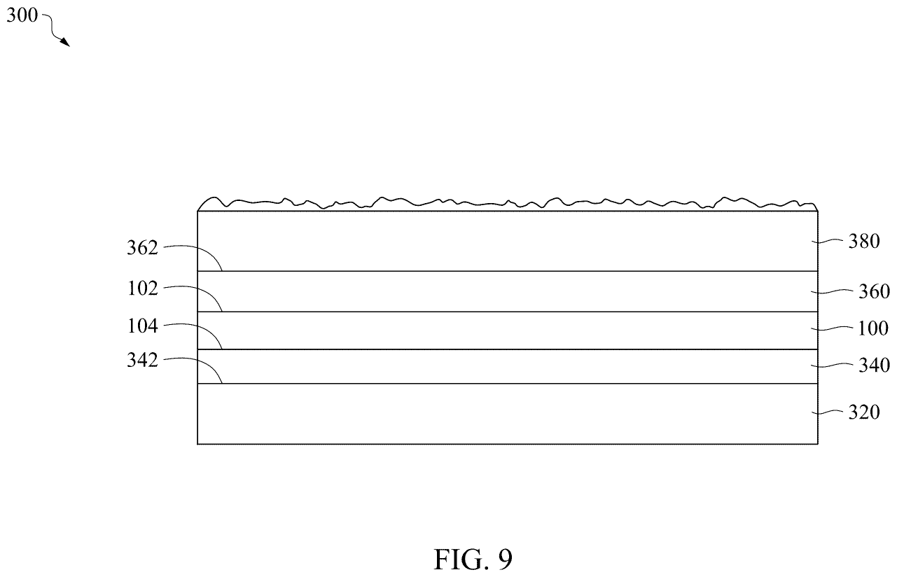

Referring to FIG. 9, FIG. 9 is a schematic diagram of a display device 300 in accordance with some embodiments of the present disclosure. The display device 300 includes a display layer 320, an adhesive layer 340, the optical film 100, an adhesive layer 360, and a particle layer 380. The display layer 320 may be a liquid-crystal display (LCD), similar display or a combination thereof. The adhesive layers 340 and 360 may be an optical clear adhesive (OCA), similar adhesives or a combination thereof. The particle layer 380 may have plural surface particles, e.g., silver particle. The display device 300 may be fabricated by following processes. For example, in the present embodiment, the adhesive layers 340 and 360 may be respectively attached to the top surface 102 and the bottom surface 104 of the optical film 100 by a laminating process or a coating process. Following, the display layer 320 may be attached to a bottom surface 342 of the adhesive layers 340 by the laminating process, and the particle layer 380 may be attached to a top surface 362 of the adhesive layers 360 to form the display device 300. Thus, the optical film 100 may effectively eliminate the issues of sparkles caused by reflected light of the particle layer 380 and concentrate energy of incident light, so that the optical film 100 may improve the performance of the display device 300.

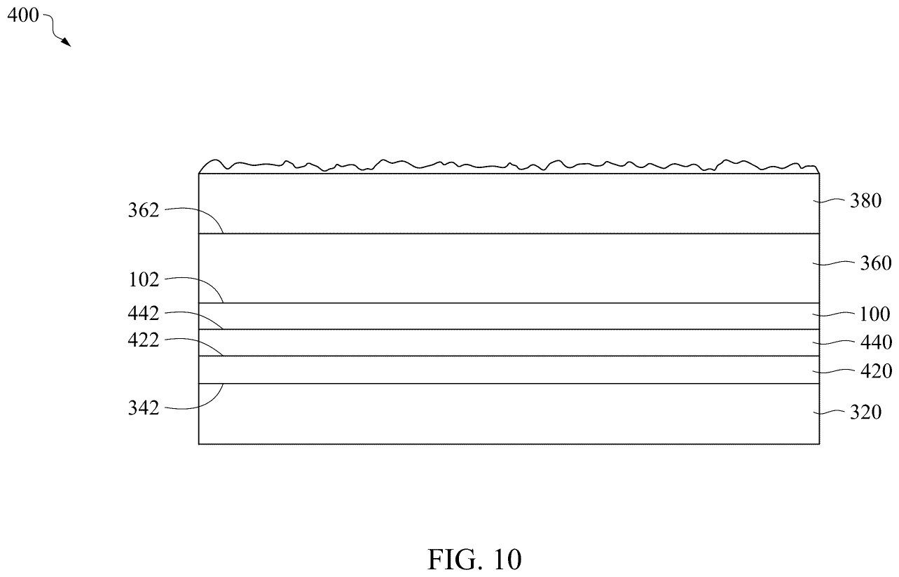

Referring to FIG. 10, FIG. 10 is a schematic diagram of a display device 400 in accordance with some embodiments of the present disclosure. The display device 400 is similar to the display device 300 in FIG. 9. The followings are the differences between the display devices 400 and 300. The adhesive layer 340 of the display device 300 (referring to FIG. 9) may be replaced by a polarizer layer 420 and an adhesive layer 440, in which the adhesive layer 440 may be a pressure sensitive adhesive (PSA), similar adhesives or a combination thereof, and a thickness of the adhesive layer 440 is less than a thickness of the adhesive layer 360, in which the thickness of the adhesive layer 440 is about 10 μm. The display device 400 may be fabricated by following processes. For example, in the present embodiment, the adhesive layer 440 may be attached to a top surface 422 of the polarizer layer 420 by the laminating process or a coating process. Following, the optical film 100 may be attached to a top surface 442 of the adhesive layers 440 by the laminating process. Following, the polarizer layer 420 may be attached to the top surface 322 of the display layer 320, and the adhesive layer 360 may be attached to the top surface 102 of the optical film 100 by the laminating process or a coating process. Following, the particle layer 380 may be attached to the top surface 362 of the adhesive layers 360 to form the display device 400. Thus, the optical film 100 may effectively eliminate the issues of sparkles caused by reflected light of the particle layer 380 and concentrate energy of incident light, so that the optical film 100 may improve the performance of the display device 400.

According to some embodiments of the present disclosure, an optical film is provided. The optical film may be a one-dimensional grating structure, a two-dimensional grating structure or a combination thereof. The one-dimensional grating structure or one of dimensions of the two-dimensional grating structure of the optical film may have different groups of periodic micro-structures, in which the periodic micro-structures are arranged in a combination of two different periods, and one of periods is larger than the other. One group of periodic micro-structures may be intersected with the other group of periodic micro-structures. Furthermore, the optical film has a primary region formed by diffraction points of the periodic micro-structures, in which the energy of the primary region is more than 70% of the energy of an incident light, and the energy differences between different regions of the primary region are less than 20%. These microstructures may homogenize the incident light through scattering and diffraction effects, preventing an excessive concentration of light at specific angles, thereby reducing the visual perception of sparkles, so that the optical film may improve the performance of a display device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical film, comprising:
a film body having a top surface; and
a two-dimensional grating structure on the top surface of the film body, wherein the two-dimensional grating structure comprises an array of micro-structures in a first dimension and a second dimension intersecting the first dimension, the micro-structures are arranged as a plurality of groups repeated by a first period in a first period direction, and at least two of the micro-structures in each of the groups are arranged in a second period in a second period direction, wherein the second period is less than the first period.

2. The optical film of claim 1, wherein an angle between the first dimension and the second dimension is in a range from 70 degrees to 90 degrees.

3. The optical film of claim 1, wherein the second period direction intersects the first period direction.

4. The optical film of claim 3, wherein an angle between the first period direction and the second period direction is in a range from 40 degrees to 90 degrees.

5. The optical film of claim 1, wherein the second period direction is parallel with the first period direction.

6. The optical film of claim 3, wherein at least two of the micro-structures in the first dimension have peaks misaligned from each other in the first dimension.

7. The optical film of claim 1, wherein the two-dimensional grating structure or one-dimensional grating structures has plural first diffraction points and second diffraction points, wherein the second diffraction points surround the first diffraction points to form a laser pattern.

8. The optical film of claim 7, wherein the laser pattern has a first region and a second region adjacent to the first region, wherein energy of the first region is greater than energy of the second region.

9. The optical film of claim 8, wherein the first region has a plurality of sub regions, wherein energy differences of the sub regions are between 0% and 20%.

10. The optical film of claim 1, wherein the first period is between 1 μm and 50 μm.

11. The optical film of claim 1, wherein the second period is between 0.5 μm and 20 μm.

12. The optical film of claim 1, wherein heights of micro-structures are in a range from one-tenth to twice of the second period.

13. The optical film of claim 1, wherein at least two of the micro-structures in each of the groups are arranged in a third period, wherein the third period is less the first period in the second period direction, and the third period is different from the second period.

14. An optical film, comprising:
a film body having a top surface and a bottom surface;
a first one-dimensional grating-structure disposed on the top surface of the film body, wherein the first one-dimensional grating-structure has a plurality of first micro-structures arranged in a first dimension, wherein the first micro-structures are arranged as a plurality of groups repeated by a first period in a first period direction, and at least two of the first micro-structures in each of the groups are arranged in a second period, wherein the second period is less than the first period; and
a second one-dimensional grating-structure disposed on the bottom surface of the film body, wherein the second one-dimensional grating-structure has a plurality of second micro-structures arranged in a second dimension intersecting the first dimension.

15. The optical film of claim 14, wherein the first period is between 1 μm and 50 μm.

16. The optical film of claim 14, wherein the second period is between 0.5 μm and 20 μm.

17. The optical film of claim 14, wherein heights of the first micro-structures or the second micro-structures are in a range from one-tenth to twice of the second period.

18. The optical film of claim 14, wherein at least two of the first micro-structures in each of the groups are arranged in a third period, wherein the third period is less the first period, and the third period is different from the second period.
